(19) United States
(12) Patent Application Publication
(10) Pub. No.: US 2006/0173928 A1
(43) Pub. Date: Aug. 3, 2006

(54) Method for controlling data review and synchronization

(75) Inventors: Joseph C. Slone, Batavia, IL (US); Jennifer Jo McClure Maze, Schaumburg, IL (US); Sara Ann Novak, Chicago, IL (US)

Correspondence Address: PILLSBURY WINTHROP SHAW PITTMAN, LLP, P.O. BOX 10500, MCLEAN, VA, 22102, US

(73) Assignee: eCPG.net Inc., Chicago, IL (US)

(21) Appl. No.: 11/183,839

(22) Filed: Jul. 19, 2005

Related U.S. Application Data
(60) Provisional application No. 60/638,196, filed on Dec. 23, 2004.

(51) Int. Cl. G06F 17/30

(52) U.S. Cl. 707/201

(57) ABSTRACT

Synchronization of product information from a Supplier to a Retailer is controlled by tracking operations and checking the status of the data. The status of the data is associated with publication and modification of the data, completion and review of the data by Suppliers and Retailers, and acceptance or rejection of the data. The data can be synchronized when all operations have been completed.

### PRIORITY INFORMATION

This application claims priority to U.S. Provisional Application No. 60/638,196, filed Dec. 23, 2004, the entire contents of which are incorporated herein by reference.

### FIELD OF THE INVENTION

The present invention relates generally to computer systems and more particularly to a software implemented method for reviewing and controlling the synchronization of data. More particularly, the present invention relates to the synchronization of data between at least two users in a data processing system.

### DESCRIPTION OF RELATED ART

Conventionally, suppliers send product information (e.g., item data) to retailers without providing a way for suppliers or retailers to review the data and control the acceptance of the data under certain conditions, such as when the data is new to the retailer, when the data is modified or corrected by the supplier, or when supplier or retailer specific information needs to be added to the data.

### BRIEF SUMMARY OF THE INVENTION

In accordance with at least one embodiment of the invention, a method of reviewing and controlling synchronization of data is provided that is capable of being used in the supplier/retailer supply chain. The present invention further relates to the process of controlling when data is synchronized.

The method of controlling the synchronization of item information between at least two users in a data processing system includes receiving item information. The item information is provided by a first user. An item review condition is then received. The item review condition may be specified by at least one of the users. It is contemplated that the item review condition may be specified by either the first user or at least one of the second users. The specified item review condition may be at least one of NEW, INITIAL_LOAD, MODIFY, CORRECT or NONE. Other review conditions are considered to be within the scope of the present invention. Published and/or modified item information is then received. The item information is preferably published and/or modified by the first user. The first user is notified of the item review condition. The approval of item information reviewed by the first user is then tracked. Following approval by the first user, one or more second users is notified of the publishing and/or modifying of the item information. The item information is then reviewed by the one or more second users. The approval of the item information reviewed by the one or more second users is then tracked. The synchronizing of the item information between the first user and the one or more second users is controlled.

It is contemplated that the data synchronization method in accordance with the present invention may be performed using a centralized processing system. This centralized processing system may be hosted by any one of the users or a third party service provider. For example, the processing system may be located on a supplier computer system, which is then linked to one or more retailer(s). It is also contemplated that the processing system may be located on a retailer computer system, which is then linked to one or more supplier(s). Furthermore, the centralized processing system may be hosted by a third party computer system or exchange whereby multiple parties can interact to exchange and synchronize data. The centralized processing system can link the computer systems of multiple retailers and multiple suppliers to synchronize data.

### BRIEF DESCRIPTION OF THE DRAWINGS

Various exemplary embodiments of this invention will be described in detail, with reference to the following figures, wherein:

FIG. 1 is a flow diagram illustrating the method and apparatus according to the at least one embodiment of the present invention;

FIG. 2 is a flow diagram illustrating operations involved in specifying Retailer Item Review Conditions;

FIG. 3 is a flow diagram illustrating operations involved in specifying Supplier Item Review Conditions;

FIGS. 4A-C include a flow diagram illustrating operations involved in tracking changes due to Item Publication or Modification;

FIG. 5 is a flow diagram illustrating operations involved in Supplier notification;

FIG. 6 is a flow diagram illustrating operations involved in tracking Supplier approval;

FIG. 7 is a flow diagram illustrating operations involved in Retailer notification;

FIG. 8 is a flow diagram illustrating operations involved in tracking Retailer approval;

FIG. 9 is a flow diagram illustrating operations involved in controlling Synchronization;

FIG. 10 is a diagram illustrating exemplary contents of the Published Item, Sync Status, Subscription Info and Supplier Review Info used in connection with the operations performed in FIGS. 2, 3, 4A-C, 5, 6, 7, 8 and 9;

FIG. 11 is a diagram illustrating one configuration of the communication between computer systems in accordance with the present invention, wherein one of the two computer systems hosts the data processing system;

FIG. 12 is a diagram illustrating one configuration of the communication between computer systems in accordance with the present invention, wherein a retailer computer system is linked to multiple suppliers;

FIG. 13 is a diagram illustrating one configuration of the communication between computer systems in accordance with the present invention, wherein the supplier computer system is linked to multiple retailers; and

FIG. 14 is a diagram illustrating one configuration of the communication between computer systems in accordance with the present invention wherein multiple computer systems are linked together through an exchange or third party computer system which hosts the data processing system.

### DETAILED DESCRIPTION OF THE INVENTION

The inefficiencies associated with providing product information from suppliers to retailers is largely due to lack of a common system where both suppliers and retailers could access the data and to a lack of defined conditions for control and synchronization at a granular level that could vary among suppliers and retailers. However, as suppliers have started to use centralized processing facilities (e.g., data pools) to collect their data and deliver it to retailers, it has become possible for suppliers and retailers to operate on the data in a centralized system that can facilitate the review, control and synchronization of the data.

The centralized system may be a computer system that may be hosted and/or operated by the supplier, the retailer or a third party exchange whereby multiple suppliers can interact with multiple retailers. Within data pools, data is commonly synchronized based on publication (i.e., the act of making the data visible to the retailer) status, modification date, and acceptance or rejection by the retailer after the data is initially sent. This approach, however, has not provided for review and control of the data synchronization before the data is initially sent. Thus, there is a need to provide a software implementable method for controlling the review and synchronization of the data.

While the present invention is described in the context of communication between a supplier and a retailer in connection with the supply of goods to a retailer and subsequent pricing of the same, it is contemplated that the method of synchronizing data described herein is not intended to be so limited. The present invention is intended to cover the synchronization of data between two or more users using a centralized processing facility.

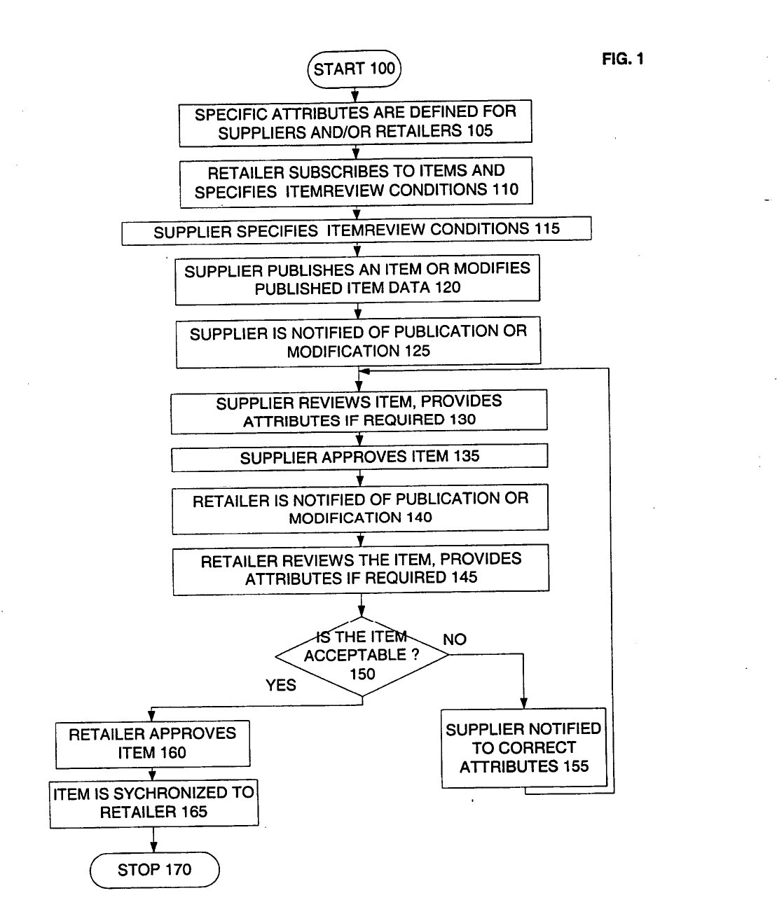

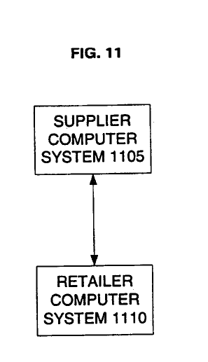

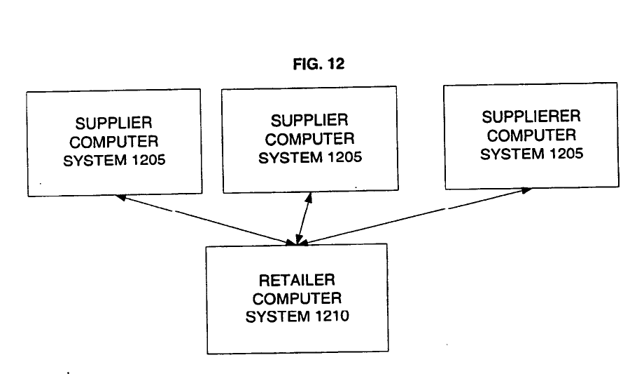

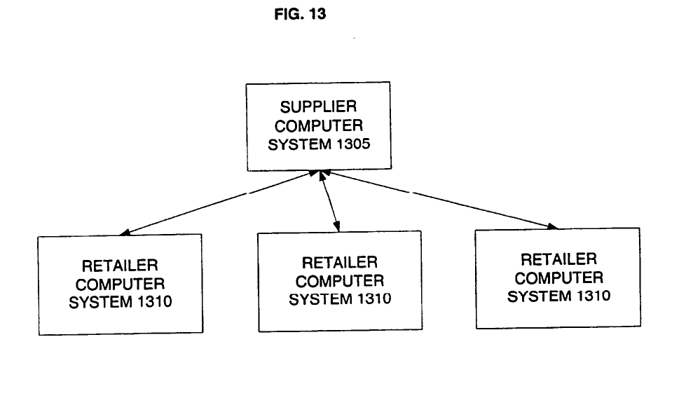

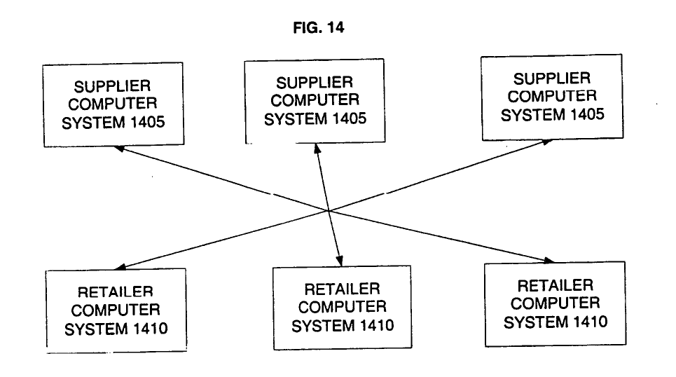

In accordance with the present invention, the software implementable method for controlling the review and synchronization of data may be accomplished using a centralized computer system that is part of either the supplier's computer system 10 (or first user's computer system), the retailer's computer system 20 (or second user's computer system) or a third party exchange 30. The supplier and retailer systems can be linked for one to one communication, as shown in FIG. 11. Multiple suppliers can be linked to a single retailer, as shown in FIG. 12. Multiple retailers can be linked to a single supplier, as shown in FIG. 13. Multiple retailers can be linked to multiple suppliers through an exchange, as shown in FIG. 14. With such as system, it is possible to obtain the configurations disclosed in FIGS. 11-13, while running through the exchange. The review and synchronization method, which can be performed by any of these systems will now be described in greater detail in connection with FIGS. 1-10.

Accordingly, at least one embodiment of the present invention provides a method to control data review and synchronization to provide higher quality data. Such a method may be triggered by or include a supplier and/or retailer and/or user specifying that data must be reviewed and approved for certain conditions, which may be the publication of new data (e.g., when a supplier is sending data for the first time to a retailer or a first user sending data for the first time a second user), publication of initial load data (e.g., when a supplier is sending data that the retailer already knows about), modification of data, correction of data (changing of certain attributes), and the like. Subsequently, the supplier and/or retailer (the first user) may be required to review, provide and accept data that is specifically defined for the supplier and/or retailer (i.e., the second user), or data that has undergone publication or modification/correction. Subsequently, once all review and acceptance has occurred, the data can be synchronized to the retailer (i.e., the second user).

FIG. 1 illustrates operations performed for a data review and synchronization process according to at least one embodiment of the present invention. The process begins at 100, at which item information is assembled by a supplier (i.e., the first user). Item information may include but is not limited to basic product descriptions, identifying information regarding products sold to consumers, product dimensions, UPC information, packaging and shipping information, or any other necessary product or item information, etc. The assembled item information may be sent later to the computer system. Control proceeds to 105, at which item attributes for specific suppliers or retailers may be defined. The item attributes are typically specified by the first user or the supplier(s). It is also contemplated that the item attributes may be specified by either the second user or the retailer(s). It is also contemplated that the item attributes may be specified by any user.

Following attribute definition, control proceeds to 110 at which a retailer (a second user) may subscribe to a first user's or supplier's item data to indicate which item data they would like to receive, and also indicate if they would like to review the data under certain conditions. These conditions may include various combinations of Publication as New (i.e., Item Review Condition is NEW), Publication as Initial Load (i.e., Item Review Condition is INITIAL_LOAD), Modification (i.e., Item Review Condition is MODIFY), Correction (i.e., Item Review Condition is CORRECT) or no condition is specified (i.e., Item Review Condition is NONE). While the conditions (NEW, MODIFY, CORRECTION, INITIAL LOAD are standards based, other conditions are considered to be within the scope of the present invention. The conditions can be modified or altered to correspond with any changes in the applicable standards. The conditions can be further modified or altered in respond to user requests or requirements.

The retailers or second users can subscribe to Items by sending a batch message to the exchange detailing the subscription conditions, the exchange is hosted by either the first user or a third party exchange. In the case of a third party exchange, the retailers or second users log on the exchange and subscribe to the Items using a Graphical User Interface (“GUI”) admin interface. The retailer or second user is then notified of the success or failure of their subscription setup, via the same mechanism that they used to initiate the setup.

Following retailer subscription, control then proceeds to 115, at which a supplier or first user may indicate if they would like to review the data under certain conditions. The supplier or first user is not notified that a retailer or second user has subscribed to their information. The supplier is notified when it is necessary to review the information via the GUI or a batch message. These data review conditions include combinations of Publication as New (i.e., Item Review Condition is NEW), Publication as Initial Load (i.e., Item Review Condition is INITIAL_LOAD), Modification (i.e., Item Review Condition is MODIFY), Correction (i.e., Item Review Condition is CORRECT) or no condition is specified (i.e., Item Review Condition is NONE). Control then proceeds to 120, at which a supplier publishes or modifies published item data that the retailer may have subscribed to. The supplier may publish or modify a item by sending a batch message to the exchange or by using the GUI. Control then proceeds to 125, at which, if a review condition for that supplier exists (e.g., supplier specified review or required supplier specific attributes), the supplier is notified. Following supplier notification, control then proceeds to 130, at which the supplier provides and reviews the data if required. The supplier reviews the Item on the exchange system by using the GUI. The supplier may provide additional item information via the GUI or by sending a batch message to the exchange. Control then proceeds to 135 at which the supplier approves the data that may have been provided, reviewed and modified.

Following supplier approval (if required), control proceeds to 140 at which the retailer may be notified of data to review as a result of the supplier publication or modification of item data, including attributes specific to the retailer that may have been previously defined (i.e., at 105). The retailer may be notified via the exchange GUI or by the exchange sending a batch message to the retailer. The retailer may then review the information via the GUI. Control then proceeds to 145, where, if required, the retailer provides and reviews the data. If the retailer does not approve the data (i.e., the answer is NO at 150), control proceeds to 155, at which the supplier is notified. Subsequently, control returns to 130 where the supplier may change the data. If, at 150, the retailer approves that data (i.e., the answer is YES at 150), control proceeds to 160 at which the data is marked as approved. After approval by the retailer, control proceeds to 165 at which the data can then be sent to the retailer. Control then proceeds to 170 at which the process ends.

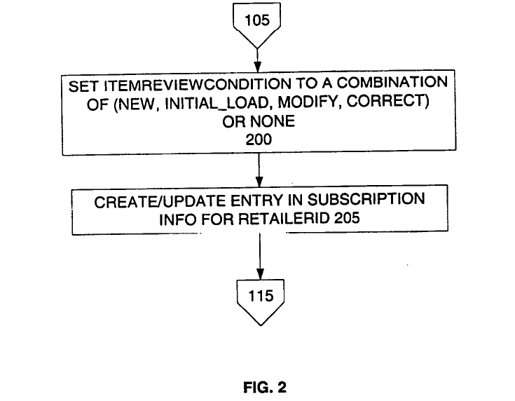

The process of retailers subscribing to item information and specifying Item Review Conditions is illustrated in greater detail in FIG. 2. The operations begin at 200, at which the retailer specifies an Item Review Condition, which is a combination of Publication as New (i.e., Item Review Condition is NEW), Publication as Initial Load (i.e., Item Review Condition is INITIAL_LOAD), Modification (i.e., Item Review Condition is MODIFY), Correction (i.e., Item Review Condition is CORRECT) or no condition is specified (i.e., Item Review Condition is NONE). This is accomplished by the retailer logging into the computer system. Once the retailer is logged in, the retailer can then subscribe and specify Item Review Conditions. These are conditions that occur on or after the supplier publication of item data. If the retailer does not want to review the data before synchronization, an Item Review Condition of None is specified. Control proceeds to 205, at which the retailer subscribes to items and an entry is created/updated in Subscription Info. It is contemplated that the retailer may complete a form or template on the retailer's computer system and then update the completed template to the computer system.

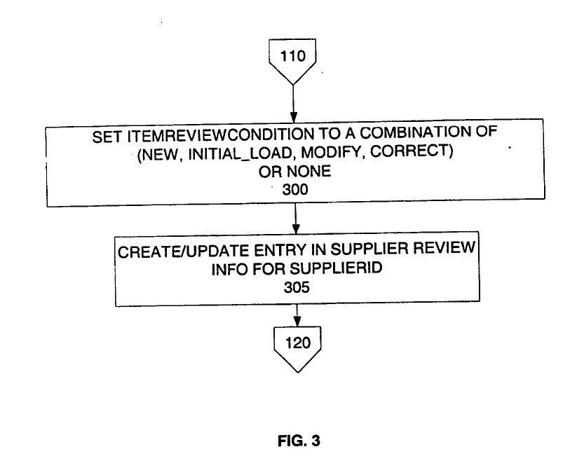

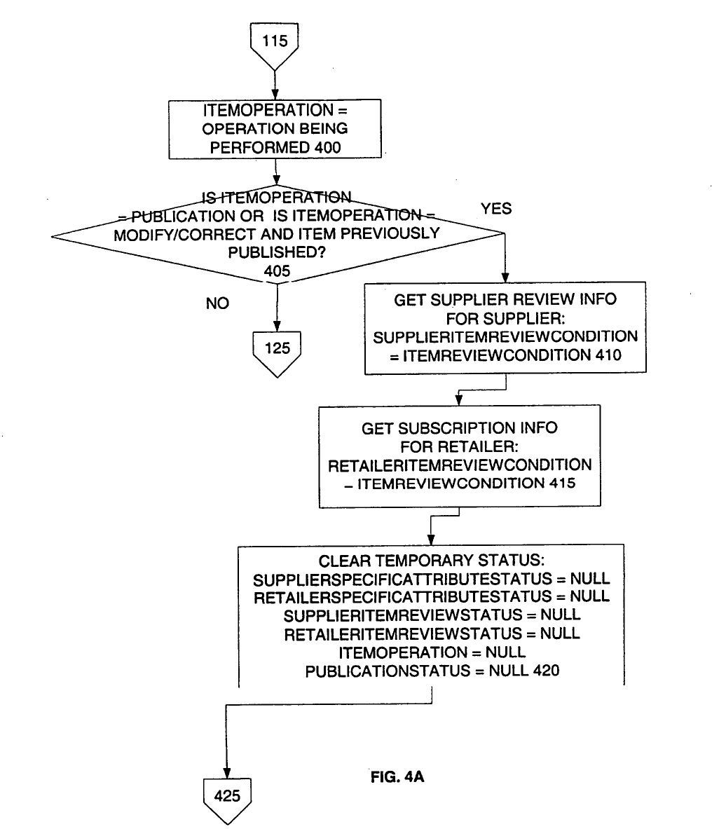

The process of suppliers specifying Item Review Conditions is illustrated in greater detail in FIG. 3. The operations begin at 300, at which the supplier specifies an Item Review Condition, which is a combination of Publication as New (i.e., Item Review Condition is NEW), Publication as Initial Load (i.e., Item Review Condition is INITIAL_LOAD), Modification (i.e., Item Review Condition is MODIFY), Correction (i.e., Item Review Condition is CORRECT) or no condition is specified (i.e., Item Review Condition is NONE). These are conditions that occur on or after the supplier publication of item data. If the supplier does not want to review the data before synchronization, an Item Review Condition of None is specified. Control proceeds to 305, at which an entry is created/updated in Supplier Review Info for the review conditions.

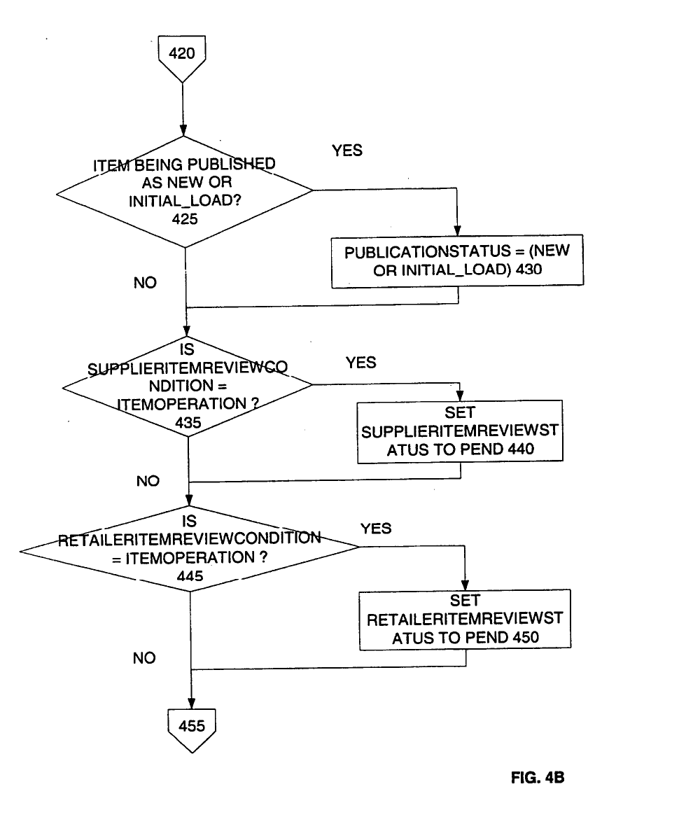

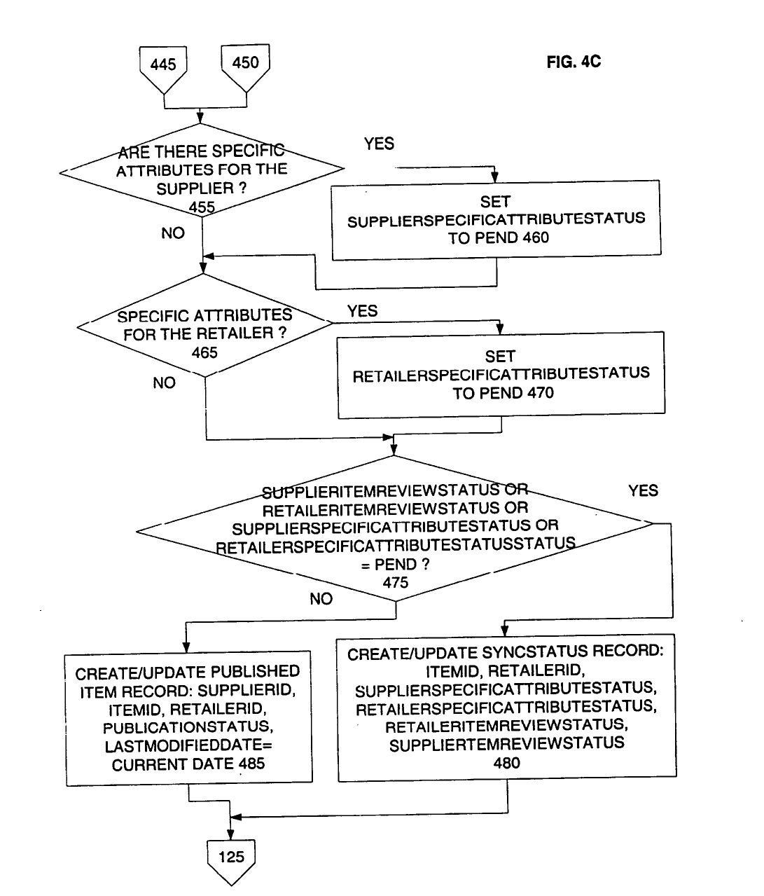

The process of tracking the synchronization status when a supplier publishes or modifies a published item that a retailer may have subscribed to is illustrated in greater detail in FIGS. 4A-C. This operation is performed by the centralized processing system. As discussed above, this may be hosted by the retailer, the supplier or a third party exchange. The operations begin at 400, at which the Item Operation is determined. If, at 405, a determination is made that the Item Operation is not applicable, control proceeds to 125 (illustrated in FIG. 1). If the Item Operation indicates that a publication is being performed or if a published item is being modified (i.e., answer is YES at 405), control proceeds to 410, at which the SupplierItemReview Condition is determined. Control then proceeds to 415, at which the RetailerItemReviewCondition is determined. Control then proceeds to 420, at which temporary status fields are cleared.

If, at 425, a determination is made that the Item is being published as New or Initial Load (i.e., answer is YES at 425), then control proceeds to 430, at which the PublicationStatus is set accordingly.

Control then proceeds to 435, at which a determination is made if the SupplierItemReviewCondition is the same as the ItemOperation. If the answer to the determination at 435 is YES, control proceeds to 440, at which the SupplierItemReviewStatus is set to PEND to indicate a review by the supplier is necessary. At this point the supplier may be notified either via the GUI or a batch message, depending on their setup. The supplier may then review the Item information via the GUI and provide any additional information.

Control then proceeds to 445, at which a determination is made if the RetailerItemReviewCondition is the same as the ItemOperation. If the answer to the determination at 445 is YES, control proceeds to 450, at which the RetailerItemReviewStatus is set to PEND to indicate review by the retailer is necessary. At this point the retailer may be notified either via the GUI or a batch message, depending on their setup. The retailer may then review the Item information via the GUI and provide any additional information.

Control then proceeds to 455, at which a determination is made if there are specific attributes for the supplier to provide. If the answer to the determination at 455 is YES, control proceeds to 460, at which the SupplierSpecificAttributeStatus is set to PEND to indicate review by the supplier is necessary. At this point the supplier may be notified either via the GUI or a batch message, depending on their setup. The supplier may then review the Item information via the GUI and provide any additional information.

Control then proceeds to 465, at which a determination is made if there are specific attributes for the retailer to provide. If the answer to the determination at 465 is YES, control proceeds to 470, at which the RetailerSpecificAttributeStatus is set to PEND to indicate review by the retailer is necessary. At this point the retailer may be notified either via the GUI or a batch message, depending on their setup. The retailer may then review the Item information via the GUI and provide any additional information.

Control then proceeds to 475, at which a determination is made if any of the status conditions is set to PEND. If the answer to the determination at 475 is YES, control proceeds to 480, at which a Sync Status record is created or updated to reflect the pending status conditions.

Control then proceeds to 485, at which a Published Item record is created or updated to reflect the PublicationStatus (as determined in 430) and the date the record is created or updated. Control then proceeds to proceeds to 125 (illustrated in FIG. 1).

If, at 405, a determination is made that the Item Operation is not applicable, control proceeds to 125 (illustrated in FIG. 1).

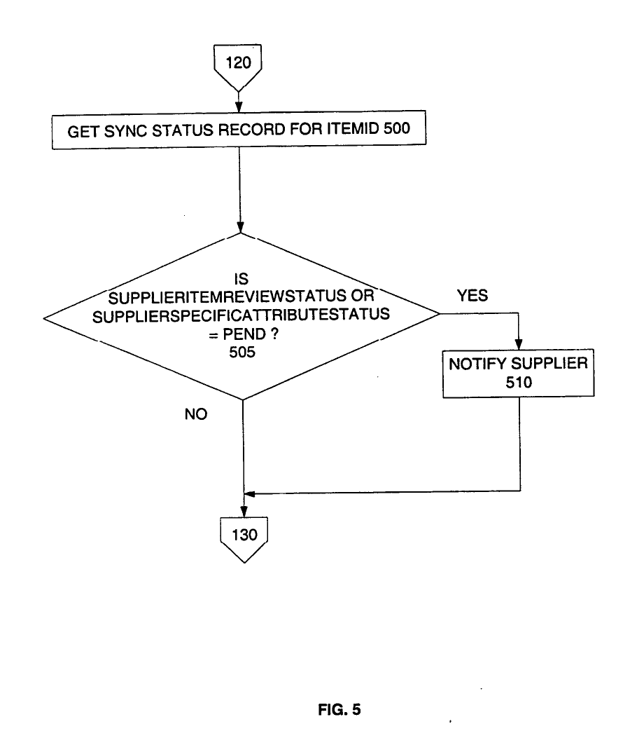

The process of a supplier being notified of publication or modification of Item data is illustrated in greater detail in FIG. 5. The operations begin at 500, at which the Sync Status record 1010 for the Item is retrieved. If at 505 a determination is made that the supplier has a pending status indicating a review condition (i.e., answer is YES at 505), control proceeds to 510, at which the supplier is notified. Control then proceeds to 130 (illustrated in FIG. 1). If, at 505, a determination is made that the supplier does not have a pending review status (i.e., answer is NO at 505), control proceeds to 130.

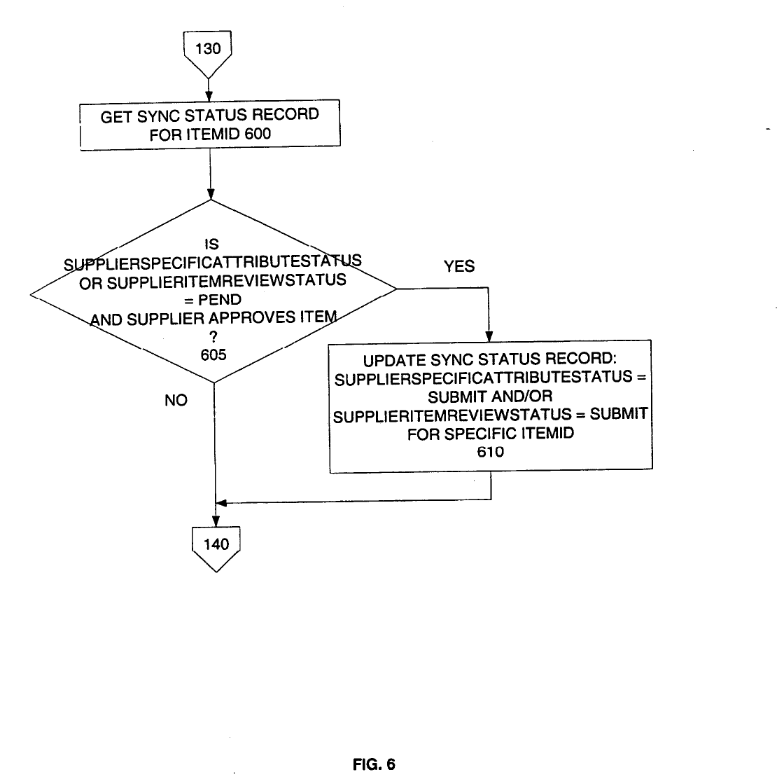

The process of a supplier approving the Item is illustrated in greater detail in FIG. 6. The operations begin at 600, at which the Sync status record 1010 for the Item is retrieved. If at 605 at determination is made that the supplier has a pending status indicating a review condition (i.e., answer is YES at 605), and the supplier approves the Item, control proceeds to 610 at which the Item is approved and the Sync Status record updated to change pending status to submit status. Control then proceeds to 140 (illustrated in FIG. 1). If, at 605, a determination is made that the supplier does not have a pending review status or does not approve the Item (i.e., answer is NO at 605), control proceeds to 140.

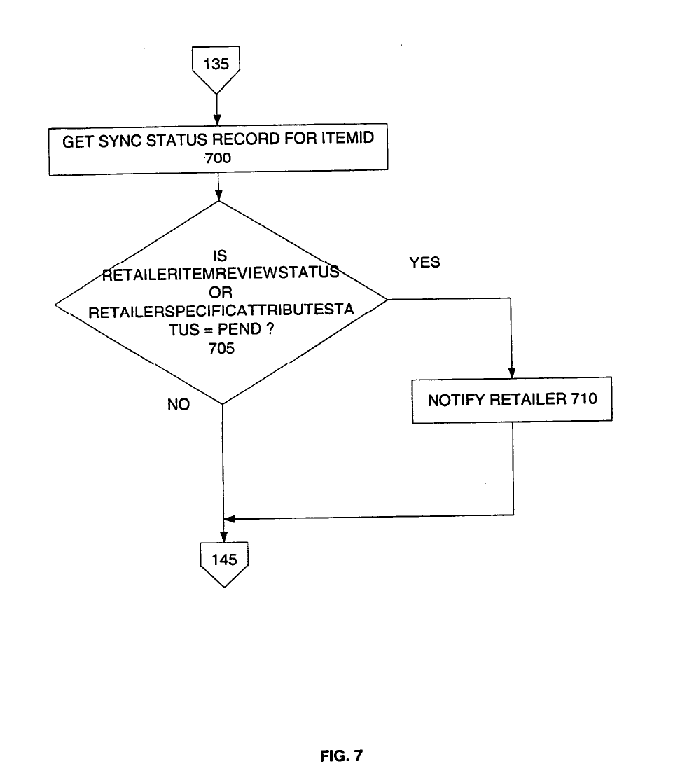

The process of a retailer being notified of publication or modification of Item data is illustrated in greater detail in FIG. 7. The operations begin at 700, at which the Sync Status record 1010 for the Item is retrieved. If at 705 a determination is made that the retailer has a pending status indicating a review condition (i.e., answer is YES at 705), control proceeds to 710, at which the retailer is notified. Control then proceeds to 145 (illustrated in FIG. 1). If, at 705, a determination is made that the retailer does not have a pending review status (i.e., answer is NO at 705), control proceeds to 145.

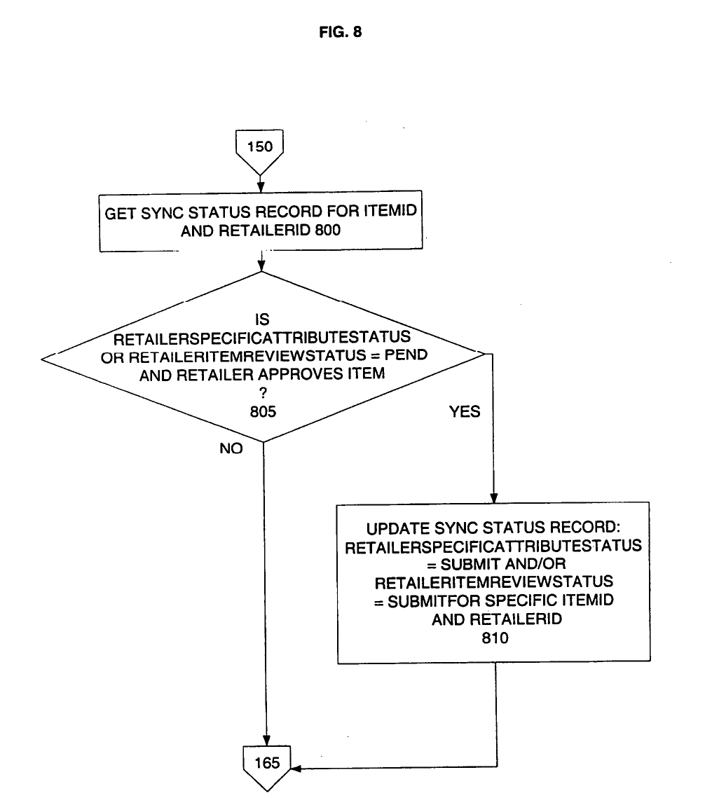

The process of a retailer approving the Item is illustrated in greater detail in FIG. 8. The operations begin at 800, at which the Sync status record 1010 for the Item is retrieved. If at 805 a determination is made that the retailer has a pending status indicating a review condition (i.e., answer is YES at 805), and the retailer approves the Item, control proceeds to 810, at which the Item is approved and the Sync Status record updated to change pending status to submit status. Control then proceeds to 165 (illustrated in FIG. 1). If, at 805, a determination is made that the retailer does not have a pending review status or does not approve the Item (i.e., answer is NO at 805), control proceeds to 165.

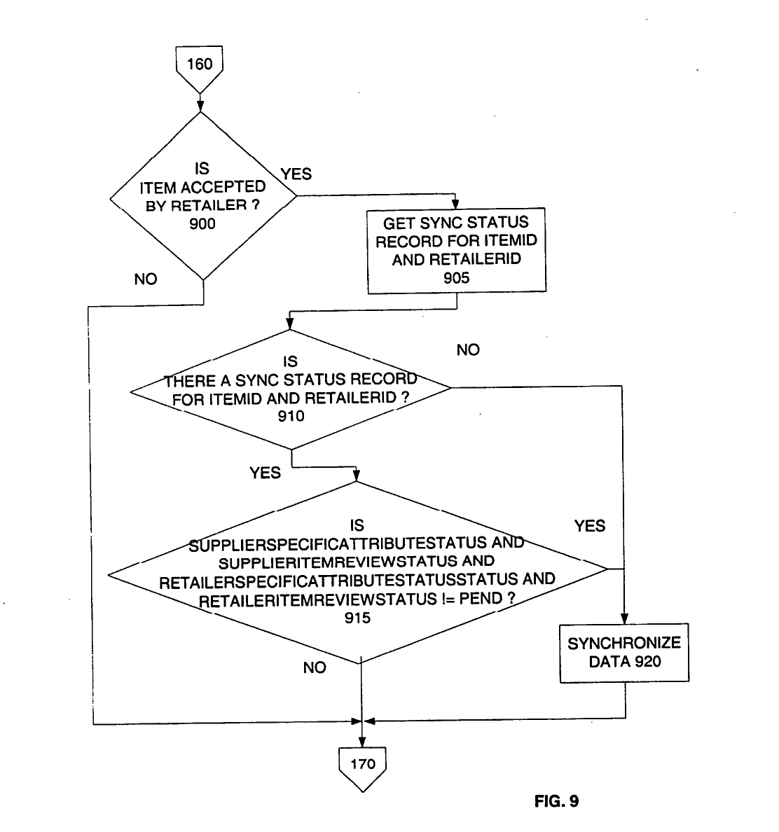

The process of controlling synchronization is illustrated in greater detail in FIG. 9. This operation is performed by the centralized processing system. As discussed above, this may be hosted by the retailer, the supplier or a third party exchange. The operations begin at 900 at which if a determination is made that the Item is accepted (default is acceptance before first synchronization) by the Retailer (i.e., answer is YES at 900), control proceeds to 905, at which the Sync status record 1010 for the Item is retrieved if it exists. If, at 910, a determination is made that there is a Sync Status record for the Item exists (i.e., answer is YES at 910), control proceeds to 915, at which if a determination is made that the item does not have pending status (i.e., answer is YES at 915), control proceeds to 920, at which the item data can be synchronized.

If, at 910, a determination is made that item does not have a Sync Status record (i.e., answer is NO at 910), control proceeds to 920, since items without a Sync Status record are not being reviewed and may be synchronized. If, at 915, a determination is made that item has pending status (i.e., answer is NO at 915), control proceeds to 170 (illustrated in FIG. 1), since items with a pending status must be reviewed and accepted before being synchronized. If, at 900, a determination is made that item has been rejected by the retailer (i.e., answer is NO at 900), control proceeds to 170, since items that have been rejected cannot be synchronized.

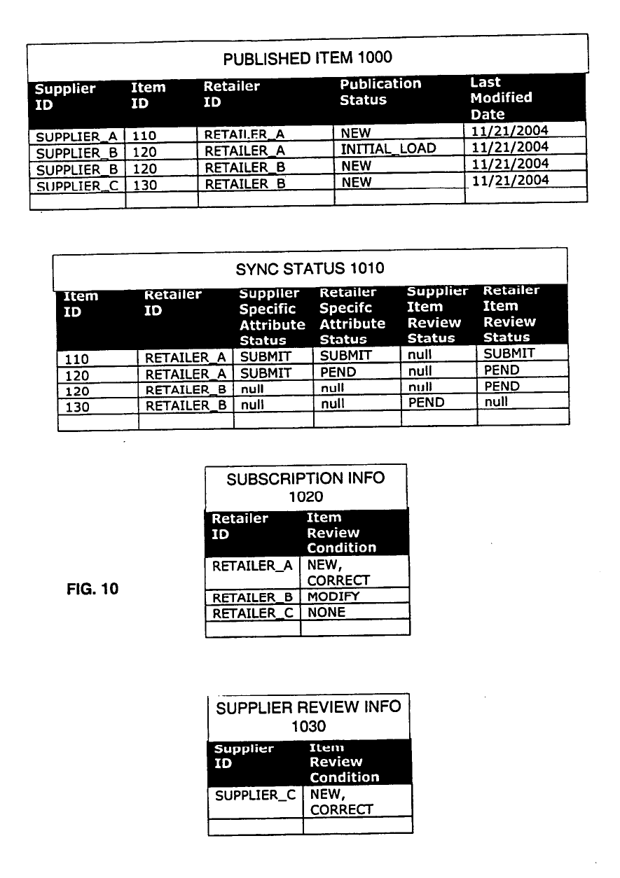

Exemplary contents of the Published Item, Sync Status, Subscription Info and Supplier Review Info tables are illustrated in FIG. 10.

The Published Item table 1000 illustrates 4 records: a retailer with an item published as New and an item published as Initial Load, another retailer with the same item published as New and a item from a different supplier published as New.

The Sync Status table 1010 illustrates 4 records. A record indicating an item with Submitted SupplierSpecificAttributeStatus, RetailerSpecificAttributeStatus, and RetailerItemReviewStatus; which is the case when there is Supplier and Retailer specific data defined and the Supplier and Retailer have approved the data. A record indicating an item with Submitted SupplierSpecificAttributeStatus and Pending RetailerSpecificAttributeStatus and RetailerItemReviewStatus; which is the case when there is Supplier and Retailer specific data defined and the Supplier has approved the data but the Retailer has not. A record indicating an item with null SupplierSpecificAttributeStatus and RetailerSpecificAttributeStatus and Pending RetailerItemReviewStatus; which is the case when no specific Supplier or Retailer data defined and the Retailer has not approved the data. And a record indicating an item with Pending SupplierItemReviewStatus; which is the case when a Supplier specified review condition has been defined and the review/approval is pending.

The Subscription Info table 1020 illustrates 3 records indicating 3 retailers with various ItemReviewCondition settings.

The Supplier Review Info table 1030 illustrates 1 record indicating 1 supplier with ItemReviewCondition settings.

Although the invention has been described above with reference to the examples illustrated in the attached drawings, it is obvious that the invention is not restricted thereto but it can be modified in many ways within the scope of the inventive idea presented in the attached claims. For example, it is contemplated that fewer fields can indicate supplier and retailer status if the Specific Attribute Status is not tracked independently.

What is claimed is:

1. A method of controlling the synchronization of item information between at least two users in a data processing system, the method comprising:
receiving item information, wherein the item information is provided by a first user;
receiving an item review condition, wherein the item review condition is specified by at least one of the users;
receiving published and/or modified item information, wherein the item information is published and/or modified by the first user;
notifying the first user of the item review condition;
tracking approval of item information review by the first user;
notifying one or more second users of the publishing and/or modifying of the item information by the first user following approval by the first user;
reviewing item information, wherein the item information is reviewed by the one or more second users;
tracking approval of the item information review by the one or more second users; and
controlling the synchronizing of the item information between the first user and the one or more second users.

2. The method according to claim 1, wherein the item review condition is specified by the first user.

3. The method according to claim 2, wherein the specified item review condition is at least one of NEW, INITIAL_LOAD, MODIFY, CORRECT or NONE.

4. The method according to claim 1, wherein the item review condition is specified by the at least one second user.

5. The method according to claim 4, wherein the specified item review condition is at least one of NEW, INITIAL_LOAD, MODIFY, CORRECT or NONE.

6. The method according to claim 1, wherein the data processing system is a computer system hosted by one of the first user and the second user.

7. The method according to claim 1, wherein the data processing system is a computer system hosted by a third party.

8. The method according to claim 7, wherein the third party is an on-line exchange.

9. A method of controlling the synchronization of item information for at least one product between at least supplier and at least one retailer in a data processing system, the method comprising:
receiving item information, wherein the item information is provided by the at least one supplier;
receiving an item review condition, wherein the item review condition is specified by at least one of the supplier and the retailer;
receiving published and/or modified the item information, wherein the item information is published and/or modified by the at least one supplier;
notifying the at least one supplier of the item review condition;
tracking approval of item information review by the at least one supplier;
notifying the at least one retailer of the publishing and/or modifying of the item information by the at least one supplier following approval by the at least one supplier;
tracking approval of item information review by the at least one retailer; and
controlling the synchronizing of the item information between the at least one supplier and the at least one retailer.

10. The method according to claim 9, wherein the item review condition is specified by the at least one supplier.

11. The method according to claim 10, wherein the specified item review condition is at least one of NEW, INITIAL_LOAD, MODIFY, CORRECT or NONE.

12. The method according to claim 9, wherein the item review condition is specified by the at least one retailer.

13. The method according to claim 12, wherein the specified item review condition is at least one of NEW, INITIAL_LOAD, MODIFY, CORRECT or NONE.

14. The method according to claim 9, wherein the item review condition is specified by the at least one retailer and the at least one supplier.

15. The method according to claim 14, wherein the specified item review condition is at least one of NEW, INITIAL_LOAD, MODIFY, CORRECT or NONE.

16. The method according to claim 9, wherein supplier approval is tracked to indicate pending review, consisting of null, pending and submitted conditions.

17. The method according to claim 16, wherein tracking of supplier approval further comprising tracking of supplier approval of overall item information.

18. The method according to claim 16, wherein tracking of supplier approval further comprising tracking of supplier providing and/or approving of specific item attributes.

19. The method according to claim 9, wherein retailer approval is tracked to indicate pending review, consisting of null, pending and submitted conditions.

20. The method according to claim 19, wherein tracking of retailer approval further comprising tracking of retailer approval of overall item information.

21. The method according to claim 19, wherein tracking of retailer approval further comprising:
tracking of retailer providing and/or approving of specific item attributes.

22. The method according to claim 9, wherein controlling the synchronization further comprising checking status information consisting of item publication, item modification, item review conditions and population of item attributes specific to one or more suppliers and/or retailers.

23. The method according to claim 9, wherein the data processing system is a computer system hosted by the retailer.

24. The method according to claim 9, wherein the data processing system is a computer system hosted by the supplier.

25. The method according to claim 9, wherein the data processing system is a computer system hosted by a third party.

26. The method according to claim 25, wherein the third party is an on-line exchange.
